(19) United States
(12) Patent Application Publication
(10) Pub. No.: US 2017/0346089 A1
(43) Pub. Date: Nov. 30, 2017

(54) BATTERY PACK

(71) Applicant: Sanyo Electric Co., Ltd., Daito-shi, Osaka (JP)

(72) Inventors: Takashi Yamamoto, Osaka (JP); Takayuki Mino, Chiba (JP); Kenichi Morina, Hyogo (JP); Natsumi Goto, Hyogo (JP); Katsunori Yanagida, Hyogo (JP)

(73) Assignee: Sanyo Electric Co., Ltd., Daito-shi, Osaka (JP)

(21) Appl. No.: 15/534,251

(22) PCT Filed: Dec. 17, 2015
(86) PCT No.: PCT/JP2015/006294

§ 371 Date: Jun. 8, 2017

(30) Foreign Application Priority Data
Dec. 26, 2014 (JP) 2014-265838

(51) Int. Cl. H01M 4/485; H01M 2/10; H01M 10/6571; H01M 10/44; H01M 10/643

(52) U.S. Cl. CPC H01M 4/485; H01M 10/44; H01M 10/643; H01M 10/6571; H01M 2/10

(57) ABSTRACT

There is provided a battery pack capable of supplying a stable output and of being charged stably in a low temperature environment (for instance, 0° C. or lower). A battery pack (1) includes: a battery group (11) having a first battery (10A) and a second battery (10B) disposed around the first battery (10A); and a heater (14) that is disposed on an outer peripheral side of the battery group (11), famed by the second battery (10B), and that generates heat by being energized by the first battery (10A). The first battery (10A) is allowed to be charged and discharged with a higher current than a current of the second battery (10B) in a temperature range lower than or equal to a predetermined temperature.

### TECHNICAL FIELD

The present invention relates to a technique for a battery pack including a battery that performs charging and discharging.

### BACKGROUND ART

In a low temperature environment (for instance, 0° C. or lower), the input/output of a secondary battery may decrease. Thus, in order to reduce decrease of the input/output of a secondary battery, there is a technique for warming the secondary battery.

For instance, PTL 1 discloses a battery pack that includes a first battery of high power type and a second battery of high capacity type, and a heater that is disposed at a position nearer to the first battery than the second battery and that generates heat. According to PTL 1, it has been suggested that when the output of the first battery of high power type decreases in a low temperature environment, the decrease of the output of the battery pack is reduced by just warming the first battery of high power type by a heater.

### CITATION LIST

### Patent Literature

PTL 1: Japanese Patent No. 5392407

### SUMMARY OF INVENTION

### Technical Problem

However, since the output of the second battery of high capacity type decreases in a low temperature environment, it is difficult to supply a stable output from the battery pack with the technique disclosed in PTL 1. In addition, since the input of the second battery also decreases, it is difficult to charge the battery pack.

Thus, it is an object of the present invention to provide a battery pack capable of supplying a stable output and of being charged stably in a low temperature environment (for instance, 0° C. or lower).

### Solution to Problem

A battery pack according to the present invention includes: a battery group having a first battery and a second battery disposed around the first battery, and a heater that is disposed on the outer peripheral side, formed by the second battery, of the battery group, and that generates heat by being energized by the first battery. The first battery can be charged and discharged with a higher current than that of the second battery in a temperature range lower than or equal to a predetermined temperature.

### Advantageous Effects of Invention

The battery pack according to the present invention is capable of supplying a stable output and of being charged stably in a low temperature environment (for instance, 0° C. or lower).

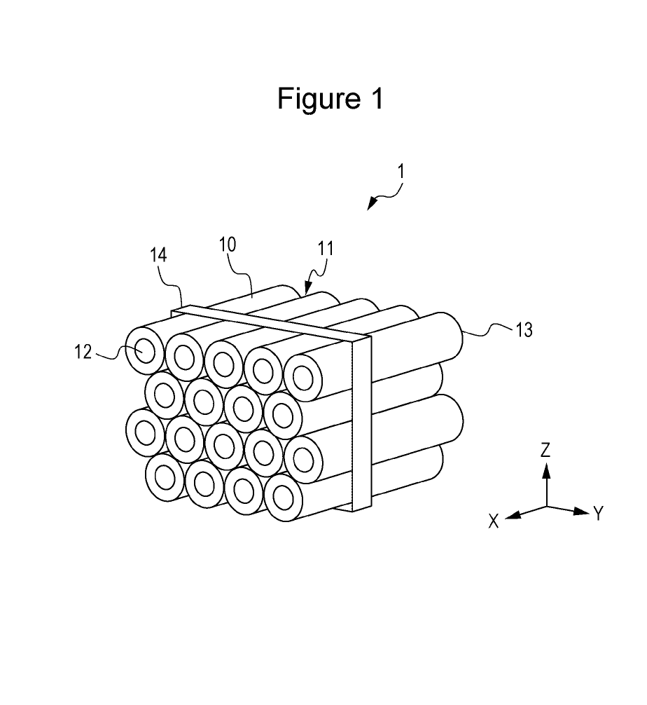

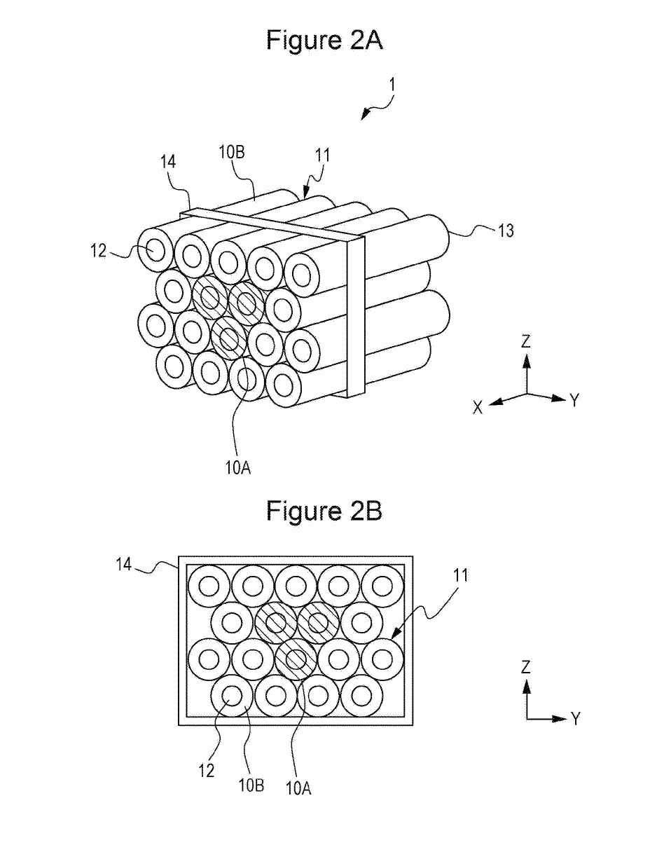

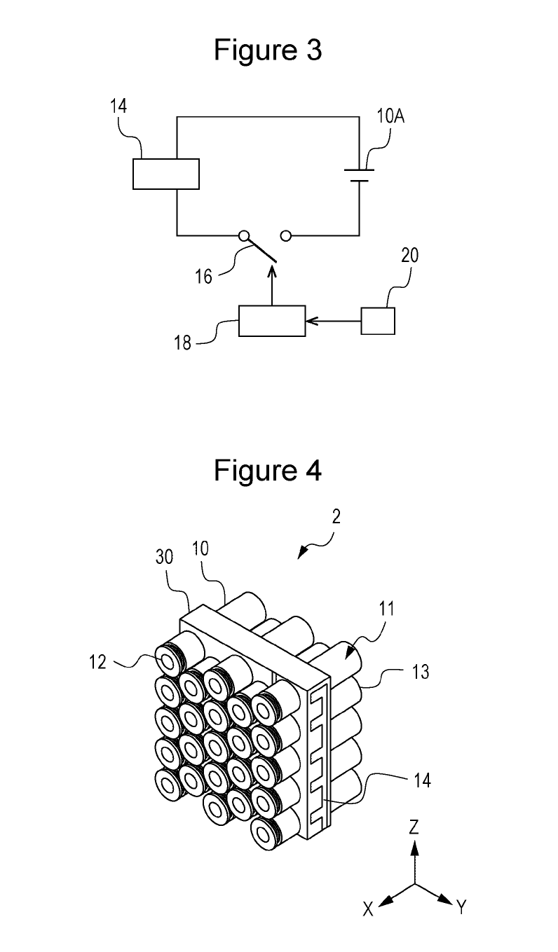

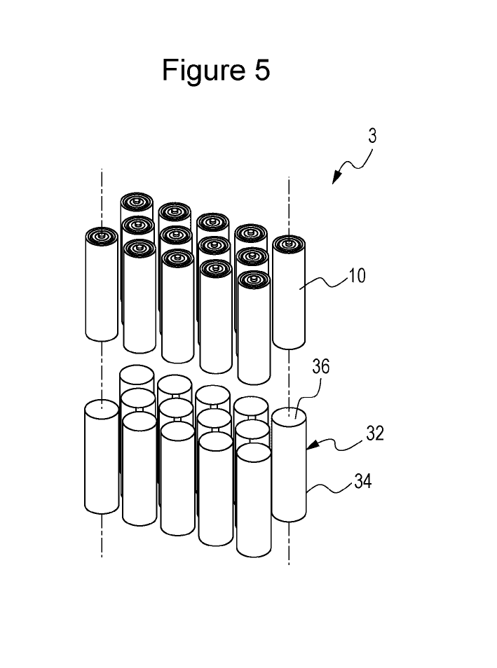

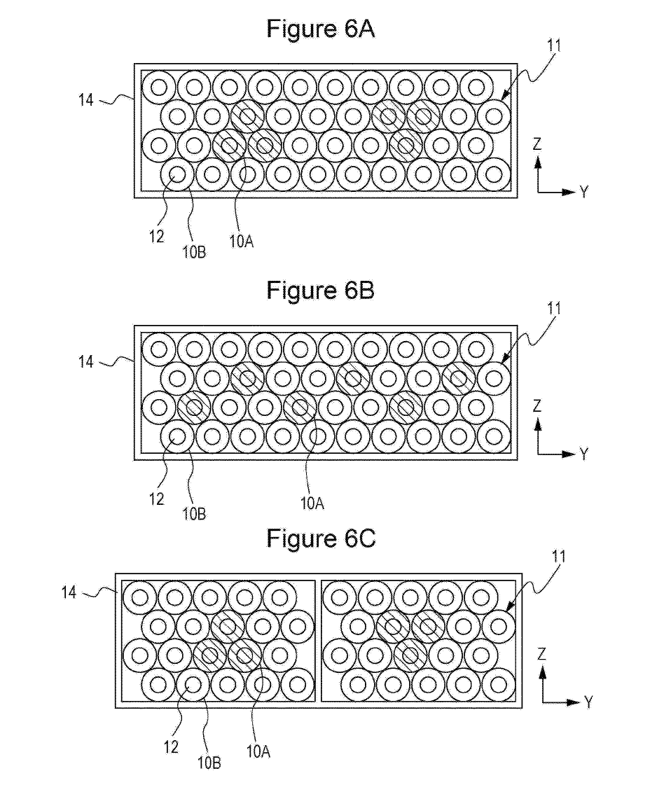

### BRIEF DESCRIPTION OF DRAWINGS

[FIG. 1] FIG. 1 is a schematic perspective view of a battery pack which is an example of this embodiment.

[FIG. 2] (A) of FIG. 2 is a schematic perspective view of the battery pack illustrating an arrangement state of a first battery and a second battery in this embodiment, and (B) of FIG. 2 is a schematic top view of the battery pack illustrating an arrangement state of the first battery and the second battery in this embodiment.

[FIG. 3] FIG. 3 is a schematic diagram illustrating a circuit configuration that drives a heater used in this embodiment.

[FIG. 4] FIG. 4 is a schematic perspective view of a battery pack that is another example of this embodiment.

[FIG. 5] FIG. 5 is an exploded perspective view of a battery pack that is another example of this embodiment.

[FIG. 6] FIG. 6 is a schematic top view of a battery pack that is another example of this embodiment.

### DESCRIPTION OF EMBODIMENTS

An embodiment of the present invention will be described below. The present embodiment is an example in which the present invention is carried out, and thus the present invention is not limited to this embodiment and may be modified as appropriate and carried out in a range without changing the gist of the invention. The drawings referred to in description of an embodiment or an example of an experiment are schematically illustrated, and the dimension or the amount of components illustrated in the drawings may be different from the actual the dimension or the amount.

FIG. 1 is a schematic perspective view of a battery pack which is an example of this embodiment. As illustrated in FIG. 1, a battery pack 1 has a battery group 11 including a plurality of unit batteries 10, and a heater 14. It is to be noted that the X-axis, Y-axis, and Z-axis in FIG. 1 are axes that are perpendicular to each other.

The heater 14 is not limited to a specific type as long as the heater 14 generates heat by being energized by a battery as described later, and the heater 14 is disposed along the outer periphery of the battery group 11 including the plurality of unit batteries 10.

The plurality of unit batteries 10 illustrated in FIG. 1 are disposed side by side in the Y-Z plane. Specifically, a row of five unit batteries 10 aligned in the Y direction and a row of four unit batteries 10 aligned in the Y direction are alternately arranged in the Z direction, and are disposed so-called in a staggered arrangement. It is to be noted that the layout and the number of the unit batteries 10 are not limited to what has been mentioned above, and may be selected as appropriate in consideration of the input/output characteristics of the battery pack 1.

The unit batteries 10 illustrated in FIG. 1 are each a cylindrical battery. In other words, each unit battery 10 extends in the X direction, and the cross-sectional shape of the unit battery 10 in the Y-Z plane is circular. As the unit battery 10, a secondary battery such as a non-aqueous electrolyte secondary battery is used. It is to be noted that description is given using a cylindrical battery as an example in this embodiment. However, without being limited to this, a rectangular battery may be used, for instance.

The unit battery 10 has a battery case, and a power generation component housed in the battery case. The power generation component is a component that performs charging and discharging, and has a positive plate, a negative plate, and a separator disposed between the positive plate and the negative plate. The separator contains an electrolytic solution.

The both ends of the unit battery 10 in the X direction are provided with a positive electrode terminal 12 and a negative electrode terminal 13, respectively. The positive plate of the power generation component is electrically connected to the positive electrode terminal 12. The positive electrode terminal 12 has a surface layer with a projection. The negative plate of the power generation component is electrically connected to the negative electrode terminal 13. The negative electrode terminal 13 is famed of a flat surface layer or a surface layer in which a safety valve (engraved mark) is disposed, the safety valve having a function of releasing an increased pressure within the battery to the outside when the battery is under abnormal conditions.

The plurality of unit batteries 10 of this embodiment have a first battery and a second battery. The first battery is a battery capable of being charged and discharged with a higher current than that of the second battery in a temperature range (hereinafter may also be referred to as a low temperature range) lower than or equal to a predetermined temperature, and the first battery is so-called a high power type battery. Here, the condition of the first battery being capable of being charged and discharged with a higher current than that of the second battery in a temperature range lower than or equal to a predetermined temperature includes a case where although the first battery has higher input/output than that of the second battery in a temperature range lower than or equal to a predetermined temperature, the first battery has lower input/output than that of the second battery in a temperature range exceeding the predetermined temperature, and a case where the first battery has higher input/output than that of the second battery in each of the temperature range lower than or equal to the predetermined temperature and the temperature range exceeding the predetermined temperature. The temperature range lower than or equal to a predetermined temperature is preferably a low temperature range lower than or equal to 0° C., and more preferably a low temperature range lower than or equal to −30° C. That is, it is preferable that the first battery be a battery that can be charged and discharged with a higher current than that of the second battery in a low temperature range lower than or equal to 0° C. (more preferably a low temperature range lower than or equal to −30° C.).

The first battery is preferably a nickel-cadmium battery or a non-aqueous electrolyte secondary battery including a negative electrode containing lithium titanate from the viewpoint of capability of providing stable input/output even in a low temperature range lower than or equal to 0° C.

The second battery is not limited to a specific type as long as the second battery satisfies the above-described input/output relationship with the first battery. However, from the viewpoint of ensuring the capacity of the battery pack 1, the second battery is preferably a battery having a greater charge and discharge capacity than that of the first battery, so-called a high capacity type battery. From the viewpoint of high capacity, the second battery is preferably a non-aqueous electrolyte secondary battery including a negative electrode containing graphite, or a non-aqueous electrolyte secondary battery including a positive electrode containing a lithium-nickel composite oxide.

Hereinafter, the arrangement of the first battery and the second battery will be described.

(A) of FIG. 2 is a schematic perspective view of the battery pack illustrating an arrangement state of the first battery and the second battery in this embodiment, and (B) of FIG. 2 is a schematic top view of the battery pack illustrating an arrangement state of the first battery and the second battery in this embodiment, and is a view of the battery pack as viewed in the X direction. As illustrated in FIG. 2, in this embodiment, three pieces of the first battery 10A and 15 pieces of the second battery 10B are used. The three pieces of the first battery 10A are disposed at a central portion of the battery group 11 including the plurality of unit batteries 10, and the 15 pieces of the second battery 10B are disposed so as to surround the three pieces of the first battery 10A disposed at the central portion.

The heater 14 is disposed along the outer peripheral portion of the battery group 11, famed by the second batteries 10B surrounding the first batteries 10A. That is, the second batteries 10B are interposed between the first batteries 10A and the heater 14.

FIG. 3 is a schematic diagram illustrating a circuit configuration that drives the heater used in this embodiment. As illustrated in FIG. 3, the heater 14 is connected to the first batteries 10A (high power type battery), and a switch 16 is disposed between the heater 14 and the first batteries 10A. When the switch 16 is in an ON state, power from the first batteries 10A is supplied to the heater 14 which generates heat. Also, when the switch 16 is in an OFF state, power from the first batteries 10A is not supplied to the heater 14 which stops generation of heat.

In this embodiment, a BMU(battery management unit) 18 illustrated in FIG. 3 makes switching between ON/OFF of the switch 16. Specifically, switching is made by the following method. The temperature of the battery pack is detected by a temperature sensor 20 disposed around the battery pack 1, and temperature data is transmitted to the BMU 18. It is then determined by the BMU 18 whether or not the above-mentioned temperature data is lower than or equal to a predetermined value. When the temperature data is lower than or equal to a predetermined value, the switch 16 is set to an ON state, and when the temperature data is higher than a predetermined value, the switch 16 is set to an OFF state. Here, the predetermined value is preferably set based on the temperature at which the input/output of the second batteries 10B (high capacity type battery) decreases. For instance, the predetermined value at or below which the switch 16 is set to an ON state is preferably set to −30° C., and is more preferably set to 0° C. In contrast, the predetermined value at or above which the switch 16 is set to an OFF state is preferably set to 10° C., and is more preferably set to 20° C.

In general, the input/output of a battery tends to decrease as the temperature drops. Therefore, when the temperature drops (for instance, 0° C. or lower), a stable output is not supplied from the battery pack to an external load. Thus, measures may be taken such that a heater is installed on the outer periphery of the battery pack to warm the battery pack. Although just the heat from the heater may warm the batteries disposed in the vicinity of the heater (that is, the batteries disposed on the outer side), the batteries disposed at a position away from the heater (that is, the batteries disposed on the inner side) do not receive heat transmitted from the heater, and are not sufficiently warmed or take a long time to be warmed. For this reason, it is difficult to supply a stable output from the battery pack in a low temperature environment. Also, when the internal batteries are attempted to be warmed only by the heat of the heater, the heater is increased in size and the power consumption of the heater also increases along with the increased size.

In this embodiment, when the temperature drops and falls below a predetermined temperature, the switch 16 is set to an ON state by the BMU 18, and when the heater 14 is energized by the first battery 10A, the heater 14 generates heat. Also, each first battery 10A also generates heat by the energization of the heater 14 by the first battery 10A. Therefore, a second battery 10B disposed on the outer side of the plurality of second batteries 10B is in the vicinity of the heater 14, and thus is warmed by the heat supplied from the heater 14. Although each second battery 10B disposed on the inner side of the plurality of second batteries 10B is at a position away from the heater 14, the second battery 10B is disposed in the vicinity of the first battery 10A heated by energizing the heater 14, and thus the second battery 10B is warmed by the heat supplied from the first battery 10A. In other words, in this embodiment, the second battery 10B is warmed by the heater 14 from the outside, and warmed by the first battery 10A from the inside. Thus, the entire battery pack is efficiently warmed. Consequently, the battery pack of this embodiment can supply a stable output even in a low temperature environment (for instance, 0° C. or lower). It is to be noted that since the first battery 10A can be charged and discharged with a higher current than that of the second battery 10B, even when the temperature drops, stable supply of power to the heater 14 is possible. As the first battery 10A, a battery system whose entropy decreases at the time of discharge, in other word, a battery system in which an exothermic reaction occurs at the time of discharge is preferably used. Specifically, the first battery 10A is preferably a nickel-cadmium battery having characteristics that an oxidation reaction occurs in the negative electrode side which generates heat at the time of discharge, or a non-aqueous electrolyte secondary battery including a negative electrode containing lithium titanate as a negative electrode material and a positive electrode containing transition metal oxide containing lithium as a positive electrode material. The positive electrode material preferably contains lithium cobalt oxide that generates a large amount of heat at the time of discharge.

The plurality of second batteries 10B of this embodiment are connected in series or in parallel, and used as a power supply for an external load. Although the plurality of first batteries 10A of this embodiment are used as the power supply of the heater 14, when surplus power (power other than the power supplied to the heater 14) is present in the first batteries 10A, the surplus power may be supplied to the external load. It is to be noted that since each first battery 10A can be charged and discharged with a higher current than that of each second battery 10B, even when the temperature drops, stable supply of power to the heater 14 or the external load is possible. After power is supplied to the heater 14 or the external load, it might be necessary to charge the battery pack in a low temperature environment. For this purpose, a remaining capacity of the first battery 10A is left to allow power to be supplied to the heater 14, and thus similarly to the case of output, the second battery 10B can be warmed even in a low temperature environment, and the battery pack can be charged. It is to be noted that the battery pack can be charged by connecting to an external power supply such as a solar battery.

Although an example, in which the heater 14 is disposed along the entire outer peripheral portion of the battery group 11, formed by the second batteries 10B, has been described in this embodiment, the heater 14 is not necessarily disposed along the entire outer peripheral portion depending on the number of the second batteries 10B or the number and arrangement of the first batteries 10A, and may be disposed on part of the outer peripheral portion. In other words, the disposition of the heater 14 in the outer peripheral side of the battery group 11, famed by the second batteries 10B is not limited to the case where the heater 14 is disposed along the entire outer peripheral portion of the battery group 11, and may include the case where the heater 14 is disposed on part of the outer peripheral portion. Although an example, in which the second batteries 10B are disposed on the entire periphery of the first batteries 10A, has been described in this embodiment, the invention is not necessarily limited to this, and a configuration may be adopted in which the second batteries 10B are disposed on part of the periphery of the first batteries 10A adjacently.

Hereinafter, modifications of this embodiment will be described. It is to be noted that hereinafter a battery referred to as the unit battery 10 indicates both the first battery 10A (high power type battery) and the second battery 10B (high capacity type battery). As described above, in the plurality of unit batteries 10, the batteries 10B are disposed so as to surround the batteries 10A.

FIG. 4 is a schematic perspective view of a battery pack that is another example of this embodiment. As illustrated in FIG. 4, a battery pack 2 has a battery group 11 including a plurality of unit batteries 10, a holder 30 that holds the plurality of unit batteries 10, and a heater 14. The heater 14 is disposed on the lateral surface of the holder 30.

The plurality of unit batteries 10 illustrated in FIG. 4 are disposed side by side in the Y-Z plane. Specifically, a row of five unit batteries 10 aligned in the Z direction and a row of four unit batteries 10 aligned in the Z direction are alternately arranged in the Y direction, and are disposed so-called in a staggered arrangement.

In the holder 30, an opening through the holder 30 is famed, and each unit battery 10 is inserted in the opening. When a gap is formed between the opening and the unit battery 10, the unit battery 10 can be fixed to the holder 30 by filling an adhesive in the gap famed between the opening and the unit battery 10. As the adhesive, for instance, an epoxy resin may be used.

The holder 30 is preferably a holder made of metal such as aluminum. Since use of the metal holder 30 improves the thermal conductivity to the unit battery 10, the heat from the heater 14 and the heat from the first battery 10A are likely to be transmitted to the second battery 10B, thereby making it possible to warm the second battery 10B in a shorter time. In addition, use of the metal holder 30 allows the second battery 10B to be more efficiently warmed with the heater 14 disposed on part of the lateral surface of the holder rather than disposed on the entire lateral peripheral surface of the holder (that is, the entire outer peripheral portion of the battery group 11, famed by the second battery 10B).

FIG. 5 is an exploded perspective view of a battery pack that is another example of this embodiment. In a battery pack 3 illustrated in FIG. 5, a plurality of holders 32 each holding the unit battery 10 form a plurality of hollow cylindrical pipes 34 that are assembled. Each unit battery 10 is housed in a housing section 36 of a hollow cylindrical pipe 34. Although a heater is not illustrated, it is disposed on the outer periphery of the holders 32 (in other words, disposed on the outer peripheral side of the battery group including a plurality of unit batteries 10). In this manner, use of the holders 32 in which a plurality of hollow cylindrical pipes 34 are assembled allows the whole unit battery 10 housed in the holder 32 to be warmed.

(A) to (C) of FIG. 6 are each a schematic top view of a battery pack that is another example of this embodiment. In the battery pack illustrated in (A) of FIG. 6, two first battery sets each including three pieces of the first battery 10A as one set are provided at a predetermined interval, and a plurality of second batteries 10B are disposed so as to surround each first battery set. The heater 14 is disposed on the outer peripheral side of the battery group, formed by the plurality of second batteries 10B. In the battery pack illustrated in (B) of FIG. 6, six pieces of the first battery 10A are provided at a predetermined interval, and a plurality of second batteries 10B are disposed so as to surround each first battery 10A. The heater 14 is disposed on the outer peripheral side of the battery group 11, famed by the plurality of second batteries 10B. Also, similarly to the battery pack illustrated in (A) of FIG. 6, in the battery pack illustrated in (C) of FIG. 6, the first batteries 10A and the second batteries 10B are disposed. However, the heater 14 is disposed not only on the outer peripheral side of the battery group 11, formed by the second batteries 10B, but also between two first battery sets. Each of these battery packs has a configuration in which power is supplied from the first battery 10A to the heater 14, and thus the heater 14 generates heat. Even with the configurations described above, the second battery 10B can be efficiently warmed, and consequently, it is possible to supply a stable output from the battery pack even in a low temperature environment. In addition, the battery pack can be charged. It is to be noted that even in these configurations, a holder holding the first batteries 10A and the second batteries 10B is preferably installed.

### REFERENCE SIGNS LIST

1 to 3 Battery pack
10 Unit battery
10A First battery
10B Second battery
11 Battery group
12 Positive electrode terminal
13 Negative electrode terminal
14 Heater
16 Switch
20 Temperature sensor
30, 32 Holder
34 Pipe
36 Housing section

1. A battery pack comprising:
a battery group having a first battery and a second battery that is disposed in the vicinity of the first battery; and a heater that is disposed on an outer peripheral side of the battery group, formed by the second battery, and that generates heat by being energized by the first battery,
wherein the first battery is allowed to be charged and discharged with a higher current than a current of the second battery in a temperature range lower than or equal to a predetermined temperature.

2. The battery pack according to claim 1,
wherein the second battery is interposed between the first battery and the heater.

3. The battery pack according to claim 1,
wherein the second battery has a larger charge and discharge capacity than a charge and discharge capacity of the first battery.

4. The battery pack according to claim 1, further comprising
a metal holder that holds the first battery and the second battery.

5. The battery pack according to claim 1,
wherein the first battery is a nickel-cadmium battery, or a non-aqueous electrolyte secondary battery including a negative electrode containing lithium titanate.
